(19) United States
(12) Patent Application Publication
(10) Pub. No.: US 2026/0366841 A1
(43) Pub. Date: Nov. 19, 2026

(54) PASSIVE CROSS-WIND AND TURBULENCE SENSING WITH NEUROMORPHIC CAMERA BASED IMAGING

(71) Applicant: Teledyne Defense Electronics, LLC, Rancho Cordova, CA (US)

(72) Inventors: Jonathan Partee, Miamisburg, OH (US); Mikhail Vorontsov, Spring Valley, OH (US)

(21) Appl. No.: 19/210,089

(22) Filed: May 16, 2025

Related U.S. Application Data
(60) Provisional application No. 63/637,045, filed on Apr. 22, 2024.

(51) Int. Cl. F41G 3/26; F41G 3/08; G01W 1/06

(52) U.S. Cl. CPC F41G 3/2644; F41G 3/08; G01W 1/06; G01W 2203/00

(57) ABSTRACT

The present disclosure describes techniques for improving the determination, also referred to as sensing, of the spatio-temporal variation of wind speed and/or atmospheric turbulence strength characteristics along a line-of-site to a target and/or trajectories for a projectile based on data captured using an optical receiver system. In some embodiments, methods and systems for determining an estimated trajectory for a projectile comprise: detecting, using a neuromorphic camera, event data indicative of a change of optical flux; determining, based at least in part on the event data, at least one optical shift indicative of a wind speed profile and/or a turbulence profile; and determining, based at least in part on the at least one optical shift, the estimated trajectory for the projectile.

### CROSS REFERENCE TO RELATED APPLICATIONS

This application claims priority to and the benefit of U.S. Provisional Patent Application No. 63/637,045 filed Apr. 22, 2024 and entitled “PASSIVE CROSS-WIND AND TURBULENCE SENSING WITH NEUROMORPHIC CAMERA BASED IMAGING,” which is incorporated herein by reference in its entirety.

### FIELD OF THE DISCLOSURE

The technologies described herein relate generally to techniques for determining the wind speed and turbulence profile along a path.

### BRIEF DESCRIPTION OF FIGURES

In the drawings, each identical or nearly identical component that is illustrated in various figures is represented by a like reference character. For purposes of clarity, not every component may be labeled in every drawing. The drawings are not necessarily drawn to scale, with emphasis instead being placed on illustrating various aspects of the techniques and devices described herein.

FIG. 1 illustrates an exemplary system for determining wind speed, in accordance with some embodiments.

FIG. 2 illustrates a geometry of the projectile trajectory path which includes regions corresponding to the presence of objects with sufficient visibility and contrast at different distances from the optical receiver, in accordance with some embodiments.

FIG. 3 illustrates an exemplary recording of a number of events per unit time registered by the neuromorphic camera during preliminary (the first cycle) path profiling through scanning of the object plane along the projectile trajectory path, in accordance with some embodiments.

FIG. 4 illustrates an exemplary recording of a number of events per unit time registered by the neuromorphic camera in the specific regions (groups of pixels) chosen based on data from the first scanning cycle, in accordance with some embodiments.

FIG. 5 illustrates an exemplary display provided to a user, in accordance with some embodiments.

FIG. 6 illustrates one exemplary implementation of a computing device in the form of a computing device that may be used in a system implementing techniques described herein, in accordance with some embodiments.

### DETAILED DESCRIPTION

The present disclosure describes techniques for improving the determination, also referred to as sensing, of the spatio-temporal variation of wind speed and/or atmospheric turbulence strength characteristics along a line-of-site to a target and/or trajectories for a projectile based on data captured using an optical receiver system with a neuromorphic camera and referred to here as event data. In some applications, the wind speed and/or atmospheric turbulence strength characteristics may be used to determine trajectories for projectiles, such as ballistic projectiles, along a path to a target. Additionally, in some applications, the wind speed and/or atmospheric turbulence strength may be used to determine optical distortions along an imaging path. The techniques described herein offer distinct advantages and increased accuracy over conventional approaches, as further described below.

The inventors have recognized and appreciated that the inadequate accuracy and speed of conventional techniques for measuring wind speed and turbulence characteristics result in challenges in accurate estimation of trajectories for projectiles. For example, the accuracy of an estimated trajectory of a projectile (e.g., an estimation of a trajectory for a projectile) may depend on the hardware for firing the projectile, the training of a user operating the hardware, the accuracy of ranging and the ability to determine wind speed and turbulence strength along the intended path for the projectile. Advancements in riflery, training, and laser ranging have addressed some of these factors. Nevertheless, wind speed and turbulence effects represent major variables affecting the accuracy of projectile trajectory estimates. For example, a precision rifle with matched ammunition, high-precision ballistic calculators, and a high-quality machine rest may remove the non-wind related obstacles to a level that may allow for the wind effect on a projectile in flight to be isolated for further analysis and possible mitigation. On the other hand, atmospheric turbulence may negatively affect the ability for accurate projective pointing. Knowledge of both wind speed and turbulence profiles at high temporal and spatial resolution potentially enables improvement of the accuracy of projectile trajectory estimates.

The inventors have further recognized and appreciated that, for some applications, spatial and temporal variations in the wind speed and/or atmospheric turbulence may impact the accuracy of an estimated trajectory for a projectile. However, existing technologies for measuring the spatio-temporal dynamics of wind and turbulence fail to provide data with sufficiently high spatial and temporal resolution-due, in part, to the physical limitations of their hardware. For example, anemometers—which are single point measurement (nodal) devices or sensors that measure wind speed at the sensor location—may have significant rotational inertia and therefore are unable to measure wind temporal dynamics with high accuracy and along the estimated projectile trajectory. Accordingly, anemometers do not provide spatially resolved measurements of wind and turbulence dynamics. Even instrumenting a range with a series of Kestrels, will not provide sufficiently accurate measurements to correctly estimate the projectile trajectory. In addition, instrumenting the projectile trajectory is not a feasible approach in applications of interest.

In other known passive turbulence and wind sensing techniques that utilize an imaging system with one or more conventional frame-based cameras (e.g., CCD based cameras) and computational hardware, the turbulence and wind characteristics are determined using digital processing of several hundred or more short-exposure image frames corresponding to “frozen” (unchanged) turbulence and wind conditions. Such techniques are based on digital tracking of pre-selected points (pixels) in sequence of short-exposure image frames that are captured by an imaging sensor camera (feature point tracking technique) or, similarly, digital tracking of a pre-selected image region represented by a fraction of overall image frame pixels. This pre-selected image region is associated with a high-contrast imaging target feature (patch), a method known as the extended image feature region tracking technique. Both of these image-based methods utilize the computation of differential shifts of pre-selected feature points or feature patches by processing large numbers (hundreds or more) of sequentially captured short-exposure image frames using conventional frame-based cameras (frame-cameras). Further computation of wind and turbulence characteristics is based on one or another known analytical expression that couples the differential tilt variance of pre-selected feature points or feature patches with the characteristics of wind speed and turbulence strength as defined by the refractive index structure parameter, commonly referred to as Cn2.

The inventors further recognize and appreciate that the computation of the differential tilt variance of pre-selected feature points or feature patches requires the processing of hundreds or more high-resolution short-exposure image frames in conventional image-based turbulence and wind sensing techniques. This requirement leads to relatively low (up to half a minute per a single measurement or more) temporal resolution in the sensing of turbulence and wind characteristics, thus preventing accurate estimation of the projectile trajectory as both turbulence and wind characteristics can change during the time required for image frame processing.

The other drawback of known methods is related to the difficulties in tracking pre-selected image patches in atmospheric conditions that are characterized by low imaging target visibility, medium-to-strong turbulence strength, and medium-to strong wind velocity. Under one (or all) of these conditions a pre-selected image feature region (image patch) may be displaced during the time interval between sequentially captured image frames (typically on the order of ten-to-hundreds of milliseconds for conventional frame-cameras) and may no longer belong to the pre-selected region. In addition, during the time required for the collection and processing of the hundreds or more image frames required for differential tilt variance computation, the pre-selected image feature patch may be reduced in contrast and hence may not be accurately identified.

On the other hand, the utilization of cameras with a faster frame rate and shorter time interval between sequential frames (inter-frame time) leads to a significant increase in the amount of imaging data to be processed and may even result in an additional slowing of the rate in sensing of wind and turbulence characteristics.

The described factors lead to both conceptual and technical challenges in applying the methods mentioned above that are typical for projectile trajectory estimation conditions.

The drawbacks of conventional techniques for the estimation of wind and turbulence spatial and temporal characteristics can be overcome with the methods disclosed herein.

The inventors have further recognized that, for some applications, wind and turbulence sensing techniques should be operative with a low probability of detection (LPD) and a low probability of interception (LPI). For example, the techniques should determine the wind speed and/or atmospheric turbulence strength along an estimated trajectory path for a projectile without increasing the probability of the equipment, or a user of the equipment, being detected during the use. Furthermore, the signals processed to determine the wind speed and/or atmospheric turbulence should have a low probability of being intercepted and should utilize compact computational hardware having low electrical power consumption.

Accordingly, the inventors have developed methods, described herein, to determine wind speed and/or atmospheric turbulence characteristics along a desired path with high spatio-temporal resolution such that the trajectories of projectiles along the path may be estimated.

In some embodiments, wind speed and/or atmospheric turbulence characteristics are determined based, at least in part, on event data captured using an imaging sensor with a neuromorphic camera, also referred to as an event camera. Neuromorphic cameras, which are discussed in more detail in the following few paragraphs, may provide output time sequences of data (referred to as an event data sequence) associated with each individual event camera pixel at a high rate (MHz or even higher). Neuromorphic cameras may have microsecond temporal resolution and a large dynamic range (up to 110 dB) that exceeds the dynamic range of conventional frame-cameras by at least 1000 times, which enables the prevention of the pixel signal from being under and overexposed as well as reducing motion-induced image blur, which are common for frame-cameras. This allows the tracking of target features (patches) and mitigation of camera movement for more accurate measurements of turbulence and wind characteristics at increased temporal rates.

Due to 1000-fold or more increase of dynamic range, an imaging system with neuromorphic cameras enables utilization of low-contrast features of target image for wind and turbulence characteristics measurements and projectile trajectories estimation, while conventional methods based on frame-based cameras, as described above, require presence of high contrast regions in image scene which may not be available. These key advantages of neuromorphic cameras provide opportunity for significant improvement of image-based turbulence and wind characterization methods to projectile trajectory estimation, especially in absence of high-contrast features in an imaging scene.

In accordance with some applications, the systems and methods described herein may be operated with a low probability of detection (LPD) and low probability of interception (LPI). For example, a rifle operator may utilize a projectile trajectory facility that determines an estimated trajectory for the projectile. The projectile trajectory facility may use event data from a neuromorphic camera to determine the wind speed and/or atmospheric turbulence characteristics. From the wind speed and/or atmospheric turbulence characteristics, the projectile trajectory facility may estimate a trajectory for the projectile. The neuromorphic camera-based imaging system may be used in some embodiments as a passive detector. Accordingly, instead of having its own dedicated light source for active target illumination, or a target containing high contrast features, the neuromorphic camera-based imaging sensor may use the ambient light illumination even in low-level visibility conditions and operate with intentionally low-contrast targets, in accordance with some embodiments. Absence of need for active target illumination may reduce the probability of detection and interception as optical, radio-frequency (RF) or acoustic signals transmitted along the path may be vulnerable to detection and/or interception. Thus, when using ambient light for illuminating objects along the path, the wind and turbulence characterization system based on neuromorphic camera would not need to transmit signals, reducing the probability of detection and/or interception as well as operate with low-contrast targets and/or low-visibility conditions.

In some embodiments, the systems and methods described herein may be integrated with a boresight such that the sight may be used to direct light from along the path onto the neuromorphic camera-based sensor. In other embodiments, the system and methods described herein may be integrated in a dedicated instrument including lenses, mirrors, or their combinations for directing light that propagates along the path to the neuromorphic camera.

Unlike frame-based cameras, a neuromorphic camera's output represents a stream of positive or negative polarity ‘events’ captured at ~MHz clock rates. The positive or negative polarity events correspond to changes in the optical flux on the sensor. Accordingly, when the optical flux is changed, each pixel that experiences a change in intensity above a pre-set threshold value generates event data. The event data may include a signal, such as a current or voltage signal, with a positive or negative polarity, where the polarity depends on whether the intensity has increased or decreased above the pre-set threshold value, respectively.

The event data may include timestamps corresponding to the time at which signals were generated by the pixels. In some embodiments, the neuromorphic camera operates as a passive sensor where events are registered when the magnitude of a generated signal exceeds a pre-set threshold. For example, if the logarithmic light intensity on a pixel increases above or decreases below a pre-set threshold, event data is produced. Accordingly, the neuromorphic camera output would not include data from pixels that do not exhibit sufficient change in the registered intensity between sequential timestamps (e.g., data from pixels corresponding to a nearly uniform image scene background) and also exclude for processing all pixels that do not belong to one or more selected for tracking target feature regions that may be used for turbulence and wind characteristics measurements. Thus, the use of the neuromorphic camera may enable a significant reduction of the amount of data to be collected and processed relative to other approaches that use frame-based cameras. Additionally, processing of events, detected by pixels inside selected feature regions, which is used for turbulence and wind characteristics measurements, can be performed at a significantly higher temporal rate that is not limited by frame rate of conventional cameras.

Imaging with a frame-based camera may face some challenges to accurately determining the spatial and temporal dynamics of the wind speed and/or atmospheric turbulence strength as measured by refractive index structure parameter known as Cn2. For example, the framerate, imaging field of view (FOV), object brightness and contrast, and image processing speed may each limit the performance of a projectile trajectory facility. With regard to the frame rate and imaging FOV, both may provide a limit on the wind speeds that may be detected. Similarly, the imaging system aperture diameter, image scene FOV and CCD matrix resolution (number of pixels) may provide a limit on the minimum angular resolution. Since a neuromorphic camera can register intensity changes at very high frequency rates, it is possible to track intensity changes happening at smaller time scale and therefore enable sensing of larger wind speeds with less uncertainty on the wind speed value.

With regard to the image processing speed, frame-based cameras capture imaging data synchronously (frame-by-frame) then all pixels belonging to regions selected for tracking target features (feature patches) processed sequentially to compute angular shifts caused by turbulence and wind along the path. By contrast, neuromorphic cameras may operate asynchronously such that signals (events) from individual pixels are read out when a corresponding change in the brightness of light at each individual pixel occurs. Thus, by not reading out signals from pixels that do not detect changes in brightness, processing time may be reduced by excluding these pixels from processing. This distinguishing characteristic of neuromorphic camera provides a new capability for simultaneous processing of event signals coming from pixels belonging to multiple image patches inside image scene thus reducing processing speed and hence improving accuracy and range in wind speed sensing.

Accordingly, the inventors have recognized and appreciated that the use of neuromorphic cameras may overcome some of the challenges associated with wind and turbulence characteristics measurement techniques that are based on a frame-based camera. Neuromorphic cameras are capable of registering optical flux changes at higher frequencies, which corresponds to megahertz framerates of conventional frame-based cameras and may provide considerably larger dynamical range as measured by signal-to-noise ratio (SNR) than conventional frame-based cameras. However, as a result of the detection architecture of neuromorphic cameras, image features which are static may be indiscernible. For example, portions of an image frame which are at constant optical flux will not register a signal. Accordingly, images generated by neuromorphic cameras do not depict a scene, instead they depict the regions of flux within a scene. As a result, determining the location of objects, or the distances between objects, when at least one object is not moving may be difficult when using a neuromorphic camera.

Accordingly, neuromorphic cameras allow determination of turbulence-induced motion by tracking image features in the pre-selected image regions that have insufficiently high contrast for wind and turbulence characteristics measurements with conventional frame-based cameras, in accordance with some embodiments. While conventional imaging techniques typically rely on the presence of high contrast region(s) in image scene, such as edge of a building contrasted against the sky background, a neuromorphic camera-based sensor may utilize a wider range of non-cooperative targets with significantly lower contrast due to its high dynamic range. Accordingly, the projectile trajectory facility may use event data from the portion of the image scene that includes wide variety of objects to determine wind speed and/or atmospheric turbulence characteristics.

The inventors have recognized and appreciated that the neuromorphic camera offers several unique advantages for atmospheric turbulence and wind speed characteristics. For example, the ability to asynchronously and independently measure signals (events) associated with each neuromorphic camera pixel enables parallel processing of signals corresponding to several feature regions inside the imaging scene and within different time intervals that are not limited by frame rate of conventional cameras. This provides better accuracy and higher spatial and temporal resolution in wind speed and atmospheric characteristics sensing.

Atmospheric turbulence strength may be described by the refractive index structure parameter

$${C}_{n}^{2} ( Cn 2 ) .$$

The refractive index structure parameter integrated along the projectile trajectory path may be determined through the processing of the event data captured by a neuromorphic camera. For example, a Cn2 value may be obtained based on computation of the variance

$$( {σ}_{F}^{2} )$$

of tuberulence-induced random fluctuations of a small-sized image feature centroid:

$${σ}_{F}^{2} ≡ 〈 {( {r}_{F} - 〈 {r}_{F} 〉 )}^{2} 〉 = α {C}_{n}^{2} , \qquad Equation 1$$

where α is a proportionality factor described by

$$α = 5.5 {LD}^{- \frac{1}{3}} {F}^{2} , \qquad Equation 2$$

L is the distance between the imaging sensor (optical receiver) of the projectile trajectory and the target (object), D is the imaging system aperture diameter, and F is the imaging system focal distance. The notation r_{F} as used herein refers to r_{F}={x_{F},y_{F}} and corresponds to the coordinate vector of a point-source image centroid, and the notation < > corresponds to averaging over an ensemble of statistically independent atmospheric turbulence realizations.

The standard approach for determination of path-integrated cross wind speed v is based on Taylor's hypothesis, where temporal changes in the atmosphere occur due to wind-induced translation of three-dimensional “frozen” spatial structures of refractive index inhomogeneities (turbulence eddies) with a path-integrated (mean) cross wind speed v. The wind speed value v may be evaluated based on this method or another, e.g., using the known relationship

v=r_{c}/t_{c}. Equation 3

Here t_{c} is the correlation time of the turbulence-induced random fluctuations of a small-size image feature centroid that may be measured using an imaging receiver of the projectile trajectory facility,

$${r}_{c} = {( 2.92 {C}_{n}^{2} {k}^{2} L )}^{- 3 / 5} \qquad Equation 4$$

is the phase fluctuation correlation parameter also known as the Tatarskii parameter, and k is wavenumber.

While the term “image” is used above, it is related to the technical description of the computation process and may be associated with a sub-image or feature region that can be reconstructed based on the flow of events accumulated during some time period, for example during a few or more milliseconds. In fact, Equation (1) can be applied to data from a neuromorphic camera without any need for image reconstruction, based solely on coordinates and timestamps of events in the considered regions and/or grid points.

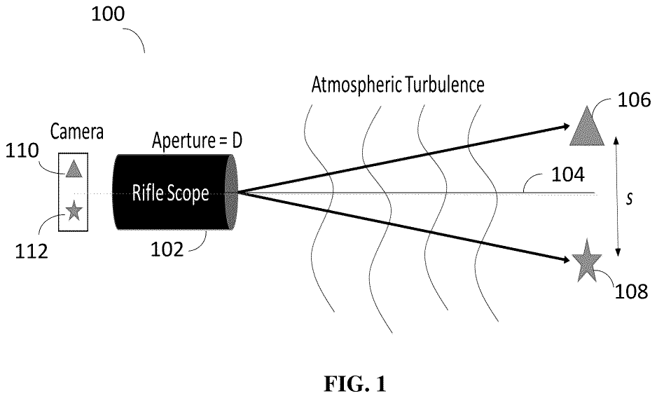

FIG. 1 illustrates an exemplary system 100 for determining wind speed, in accordance with some embodiments. As shown in FIG. 1, a rifle scope 102, having an aperture D, is configured to direct incident light, received from the path of interest, onto a camera detector. When the optical system used to direct light from along the path onto the neuromorphic camera is not integrated with a boresight, and a dedicated instrument is utilized, the path profiling method can be applied. In this case multiple regions corresponding to objects at different distances along the path can be considered. A resolved feature from the image sub-region that has sufficient contrast is aligned with the plane orthogonal to the optical axis as indicated by line 104. Due to atmospheric turbulence and cross wind, selected object features as seen in the camera image plane can be laterally shifted between a first position 106, indicated by the triangle, and a second position 108, indicated by the star. The observed shift at the camera detector plane corresponds to positions 110 and 112. This object feature shift triggers event data with negative and positive polarities, respectively. A projectile trajectory facility may determine an optical shift, based on the recorded event data.

In some embodiments, the projectile trajectory facility may be configured to determine wind speed during daylight times. In some embodiments, the projectile trajectory facility may be configured to determine wind speed during night times.

The projectile trajectory facility may determine a wind speed based on the event data. In some embodiments, the wind speed may be determined from the event data using artificial intelligence techniques such as machine learning techniques. For example, a statistical classifier trained to determine a wind speed based on event data may be used to determine the wind speed (and may be considered to be an example of an artificial intelligence technique and a machine learning technique). In some embodiments, artificial intelligence techniques may be used to determine an estimate trajectory for a profile. For example, machine learning techniques may be trained to determine an estimated trajectory for a projectile. For example, a statistical classifier trained to determine an estimated trajectory may be used to determine an estimated trajectory.

In some embodiments, determining an estimated trajectory for a projectile may comprise using an artificial intelligence technique to determine an estimated trajectory for the projectile based at least in part on at least one optical shift. The artificial intelligence technique may comprise a machine learning technique. The machine learning technique may comprise using a statistical classifier.

In some embodiments, known analytic equations may be used to determine the cross wind speed profile v(z) from the refractive index structure parameter profile

$${C}_{n}^{2} ( z ) ,$$

where z is distance from the projectile trajectory facility to the target.

In some embodiments, the unique advantages of a neuromorphic camera can be utilized with the path profiling technique that may provide improvement in the accuracy of

$${C}_{n}^{2}$$

and cross wind speed profiling for more accurate projectile trajectory estimation.

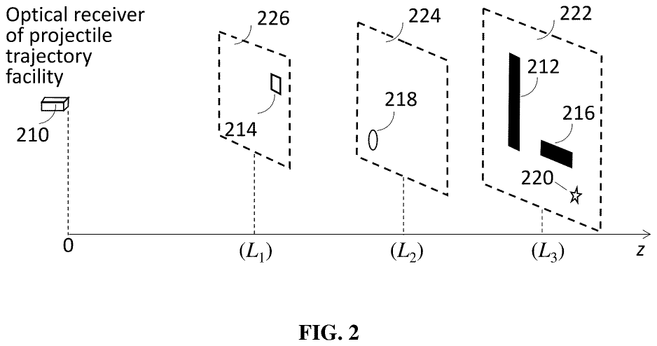

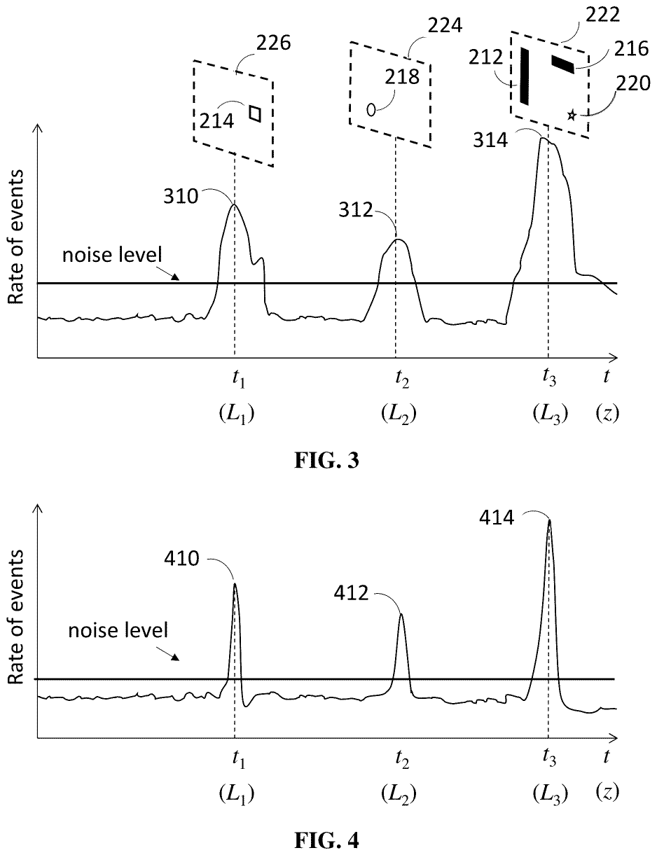

The wind and turbulence profiling method using neuromorphic-camera based path profiling through object plane scanning proposed and described here is illustrated in FIG. 2, FIG. 3 and FIG. 4, where FIG. 2 illustrates geometry of the projectile trajectory path from a projectile trajectory facility equipped with a passive optical receiver or imaging system with a neuromorphic camera used for turbulence and wind speed determination, in accordance with some embodiments described herein.

With the utilization of a neuromorphic camera, a conventional optical receiver and or imaging system used for wind speed and turbulence characteristic sensing can be modified to include rapid object plane scanning along a projectile trajectory, enabling depth (distance), turbulence strength

$$( {C}_{n}^{2} ) ,$$

and wind speed (v) estimation along a projectile trajectory path from the event data captured by the neuromorphic camera. The path profiling may be achieved by using imaging lens motion or by applying other means. For example, the path profiling using imaging motion to adjust the focal plane may be used to adjust the view between object planes which are located at different distances away from the lens. During the process of object plane scanning along a pre-selected projectile path (along the z axis in FIG. 2) a group of neuromorphic camera pixels report events that occur within FOV regions 222, 224, 226 corresponding to the presence of well-focused and sufficiently high-visibility objects (objects 212 through 220 in FIG. 2) located in a small vicinity of the corresponding image planes along a selected projectile trajectory. These event camera pixels or a portion of the group of event camera pixels can be identified as feature regions and utilized for retrieval of wind speed and turbulence characteristics corresponding to the current image-plane distance (correspondingly, distances L₁, L₂ and L₃ in FIG. 2) during scanning along a selected projectile trajectory path, thus providing the information necessary to build a corresponding wind speed profile and a corresponding turbulence profile. A neuromorphic camera based optical receiver with object plane scanning capability can provide fast (on the order of a few seconds or less) wind speed profiling and turbulence profiling due at least in part to the high dynamic range, high data (event) rate, and capability for asynchronous readout (e.g., parallel processing of output event signals)

In the example shown in FIG. 2 of turbulence and wind speed characterization using object scanning in, several objects or groups of objects, also referred to as targets, namely 212 through 220 are located along a selected projectile trajectory path at different distances (correspondingly L₁, L₂ and L₃) from the projectile trajectory facility 210 within the FOV of the optical receiver system equipped with a neuromorphic camera.

In some embodiments, the number of objects or groups of objects can be smaller or larger. Each or some of the objects (targets) may have sufficiently high contrast features (patches) so as to be detected by a neuromorphic camera and used for digital image feature tracking during object plane scanning. For example, when an object or group of objects (e.g., objects 212, 216 and 220 are located at a distance L₃, or an object 218 is located at a distance L₂, or an object 214 is located at a distance L₁) are located in the corresponding image planes (image planes 222, 224 and 226) of the optical receiver during object scanning. The neuromorphic camera may detect event data based on the object or group of objects where the event data is generated by an optical shift, or multiple optical shifts, indicative of a wind speed profile and a turbulence profile.

In some embodiments, the number of objects can be as small as one object with one or several selected high contrast feature regions. In other embodiments, it can be tens of objects located at different (from one to many) distances from the projectile trajectory facility. For example, the objects may include trees, bushes, grass, characteristic landscape features, etc., that are located along the imaging path of the selected projectile trajectory. The high contrast feature regions may be a single region, a number of regions, or a grid of small regions. In some embodiments, small regions may include less than 1000 pixels, less than 500 pixels, or less than 100 pixels. For example, the small regions may include between 1 and 1000 pixels, 5 and 500 pixels, or 10 and 100 pixels in a field of view of the camera. The high contrast region may be used for evaluating the corresponding optical shift or optical shifts that are observed due, in part to, the degree of contrast in the high contrast region.

In some embodiments, the high contrast region may be identified using an edge detection algorithm. In some embodiments, a user may select the high contrast region. In some embodiments, the contrast region may be identified using an artificial intelligence technique. The artificial intelligence technique may comprise a machine learning technique such as a statistical classifier.

In some embodiments a contrast region may be identified using an artificial intelligence technique to identify the contrast region. The artificial intelligence technique may comprise a machine learning technique. The machine learning technique may comprise a statistical classifier.

Scanning of the optical system object plane, by changing the optical receiver focal distance, enables obtaining the high contrast target features that may be used for atmospheric turbulence and wind speed determination. For example, an atmospheric turbulence and wind speed determination may be made using an object or a group of objects that are located in a small vicinity of corresponding image planes (planes 222, 224 and 226 in FIG. 2) while other objects, that are not in the image plane, have low contrast and may not trigger event signals at neuromorphic camera pixels. During the object scanning cycle the camera's object plane distance is identified (this distance depends on scanning speed and imaging system focal length), which enables estimation of the distance to an object or group of objects that are located in the corresponding image planes (correspondingly, distance L₁, or L₂, or L₃ in FIG. 2).

In some embodiments, scanning of the optical system object plane enables detecting, using a neuromorphic camera, first event data at a first focal plane and second event data at a second focal plane. The first event data being indicative of a first change of optical flux and the second event data being indicative of a second change of optical flux. An optical shift, indicative of wind and atmospheric turbulence profiles may be determined using the first and second event data. Accordingly, the optical shift may be used to determine the trajectory of the projectile.

In some embodiments an estimated trajectory of a projectile may be determined using an artificial intelligence technique to determine the estimated trajectory for the projectile based at least in part on at least on optical shift. The artificial intelligence technique may comprise a machine learning technique such as a statistical classifier.

In some embodiments, more than two focal planes may be used. For example, determining the trajectory for the projectile, may include detecting a third event data at a third focal plane, the third event data being indicative of a third change of optical flux. In some embodiments, more than three focal planes may be used, as aspects of the technology described herein are not limited in this respect.

In some embodiments, an array of pixels of the neuromorphic camera may be used to detect first event data from a first region of interest of the array while imaging a first focal plane. The same array of pixels may further be used to detect second event data from a second region of interest of the array while imaging a second focal plane. In some embodiments, the first region of interest may correspond to a first set of pixels of the neuromorphic camera and the second region of interest may correspond to a second set of pixels of the neuromorphic camera, wherein the first set of pixels and the second set of pixels are different sets of pixels of the array of pixels of the neuromorphic camera. In some embodiments, the first set of pixels and the second set of pixels may be the same set of pixels of the array of pixels of the neuromorphic camera.

In some embodiments, a first optical shift may be determined from the first event data and a second optical shift determined from the second event data. The first optical shift and second optical shift may be used to determine a wind speed and wind direction. Based at least in part on the wind speed and wind direction, the trajectory of the projectile may be determined.

FIG. 3 illustrates an exemplary recording of a number of events per unit time (e.g., per second), also referred to as the rate of events, registered by the neuromorphic camera during one cycle of image-plane scanning for the projectile trajectory path shown in FIG. 2. The plot showing the number of events per unit time, referred to here as the scanning curve, may be obtained with the object-plane scanning technique described herein. The scanning curve may be utilized for turbulence and wind speed profiling as described herein.

Peaks 310, 312 and 314, in the scanning curve example shown in FIG. 3, correspond to timestamps t₁, t₂ and t₃ of the sequential appearance of high contrast objects at the neuromorphic camera detector during object plane scanning along the path. Based on the measured timestamps t₁, t₂ and t₃ associated with the scanning curve maxima and with knowledge of scanning speed and imaging system focal distance, one may easily compute the corresponding distances L₁, L₂ and L₃ to the high-visibility objects along the path.

Object-plane scanning may be performed in two cycles, in accordance with some embodiments described herein. For example, the first scanning cycle enables location of objects of interest for turbulence and wind speed determination along the path based on the position of peaks on the scanning curve measured during the first scanning cycle. In the example shown in FIG. 2 and FIG. 3 these peaks correspond to distances L₁, L₂ and L₃. A pixel or a group of neighboring neuromorphic camera pixels which correspond to the highest event data rate per pixel, in the vicinity of the scanning curve maxima (peaks), are identified as feature region pixels corresponding to different distances for use in both turbulence and wind speed characterization. During the second scanning cycle only event data from the feature region pixels, identified in the first cycle, are collected and processed to be used for turbulence and wind speed determination. The selection of only feature region pixels among all neuromorphic camera pixels may result in sharper peaks in the scanning curve, as illustrated in FIG. 4 (peaks 410, 412 and 414), and a higher signal-to-noise ratio in the determination of the turbulence refractive index structure parameter

$${C}_{n}^{2} ( {z}_{j} )$$

and crosswind v(zⱼ) values corresponding to the peak distances zⱼ from the projectile trajectory facility optical receiver to the image plane of selected high-contrast objects along the path, where j=1, . . . , N and N is the number of high-visibility objects at different distances selected for turbulence and cross wind speed determination during the first scanning cycle.

In some embodiments known methods and equations, e.g., Equations 1 through Equation 4, may be applied to determine the refractive index structure parameter

$${C}_{n}^{2} ( {z}_{j} )$$

and crosswind v(zⱼ) values integrated over the path of length zⱼ based on processing of feature region pixels of the frame-based camera. The utilization of a neuromorphic camera provides additional advantages such as a high dynamic range, a higher signal-to-noise ratio enabling the use of low-contrast objects along the path, and a high signal processing rate as described above. These known methods and equations for path-integrated

$${C}_{n}^{2} ( {z}_{j} )$$

and crosswind v(zⱼ) determination may be applied to each object, or to one object, or to a set of objects located inside the FOV along the path.

The path-integrated

$${C}_{n}^{2} ( {z}_{j} )$$

and crosswind v(zⱼ) values may be determined using these methods and equations which can be represented in the form of Equation 5 and Equation 6 below.

$${C}_{n}^{2} ( {z}_{j} ) = {{\int }_{z = 0}}^{{z}_{j}} {C}_{n}^{2} ( z ) dz = {{\int }_{z = 0}}^{{z}_{j - 1}} {C}_{n}^{2} ( z ) dz + {{\int }_{{z}_{j - 1}}}^{{z}_{j}} {C}_{n}^{2} ( z ) dz = {C}_{n}^{2} ( {z}_{j - 1} ) + {{\int }_{{z}_{j - 1}}}^{{z}_{j}} {C}_{n}^{2} ( z ) dz = {C}_{n}^{2} ( {z}_{j - 1} ) + {C}_{n}^{2} ( Δ {z}_{j} ) \qquad Equation 5$$

$$v ( {z}_{j} ) = {{\int }_{z = 0}}^{{z}_{j}} v ( z ) dz = {{\int }_{z = 0}}^{{z}_{j - 1}} v ( z ) dz + {{\int }_{{z}_{j - 1}}}^{{z}_{j}} v ( z ) dz = v ( {z}_{j - 1} ) + {{\int }_{{z}_{j - 1}}}^{{z}_{j}} v ( z ) dz = v ( {z}_{j - 1} ) + v ( Δ {z}_{j} ) , \qquad Equation 6$$

In some embodiments, the refractive index values

$${C}_{n}^{2} ( {z}_{j} ) and {C}_{n}^{2} ( {z}_{j - 1} ) ,$$

cross wind speed values v(zⱼ), and v(zⱼ₋₁)—which may be integrated along the trajectory—are computed based on the processing of neuromorphic camera pixels belonging to the feature regions for the corresponding distances zⱼ and zⱼ₋₁. Correspondingly, the refractive index

$${C}_{n}^{2} ( Δ {z}_{j} )$$

and cross wind speed v(Δzⱼ) values inside the projectile trajectory segment of length Δzⱼ=zⱼ−zⱼ₋₁ between the selected distances zⱼ and zⱼ₋₁ along the path can be determined based on the computed path-integrated values

$${C}_{n}^{2} ( {z}_{j} ) , {C}_{n}^{2} ( {z}_{j - 1} ) ,$$

and v(zⱼ), v(zⱼ₋₁), as described below in Equation 7 and Equation 8.

$${C}_{n}^{2} ( Δ {z}_{j} ) = {C}_{n}^{2} ( {z}_{j} ) - {C}_{n}^{2} ( {z}_{j - 1} ) , \qquad Equation 7$$

$$v ( Δ {z}_{j} ) = v ( {z}_{j} ) - v ( {z}_{j - 1} ) , \qquad Equation 8$$

where zⱼ₌₀=0 corresponds to measurements at the projectile trajectory facility.

In some embodiments, both the atmospheric turbulence refractive index structure parameter

$${C}_{n}^{2} ( z )$$

and cross wind speed profiles v(z) can be computed by fitting curves for the sets of path-integrated values

$$\{ {C}_{n}^{2} ( {z}_{1} ) , {C}_{n}^{2} ( Δ {z}_{2} ) , … , {C}_{n}^{2} ( Δ {z}_{N} ) \}$$

and {v(z₁), v(Δz₂), . . . v(Δz_{N})}. For example, the proposed turbulence and cross wind speed profiling may be performed using a single image-plane scanning cycle or many scanning cycles for better accuracy in estimation of the wind and turbulence profiles.

The object-plane scanning method, described herein, can be used with a conventional imaging system configured with a frame-based camera, however the utilization of a neuromorphic camera provides many advantages relative to the use of frame-based cameras. Due to the large dynamic range, the neuromorphic camera-based object-plane scanning method enables detection of feature regions for low visibility objects inside the FOV along the path, which cannot be detected with frame-based cameras. FIG. 2 illustrates an example configuration where objects along the path that cannot be utilized for the object-plane scanning method of turbulence and cross wind speed determination because of insufficiently high visibility are shown by the non-filled shapes 214, 218 and 220.

As described above, the measured autocorrelation function may be used for the determination of the correlation time t, and may be fit to equations 3 and 4 to determine a path-integrated (mean) wind velocity along the path. If the wind and

$${C}_{n}^{2}$$

profiles are not constant, an estimation of the wind speed should be performed at each point along the direction of propagation, z, based on, for example, the object-plane scanning method described herein. Accordingly, the velocity or “holdover” may then be provided to the user, in accordance with some embodiments. Holdover refers to the positioning of a rifle scope crosshairs off of the center of the scope to compensate for the effect of wind or gravity. In some embodiments, the wind velocity may be used to estimate a trajectory of the projectile to a desired target and provide feedback to the user on how to adjust aiming of the projectile in order to produce the determined trajectory of the projectile.

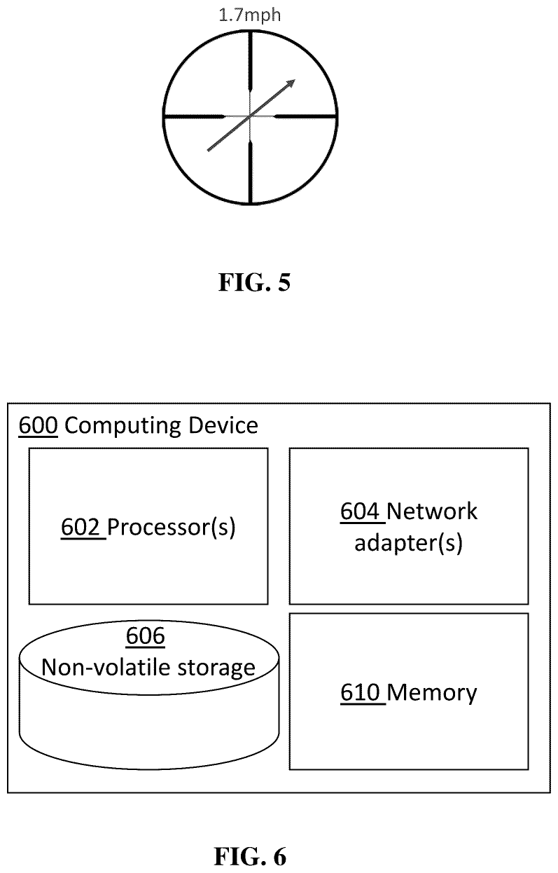

FIG. 5 illustrates an example of a display provided to a user, in accordance with some embodiments. As shown in FIG. 5, a visual indicator may be displayed to a user through a scope to indicate a direction of the wind along with a numeric determination of the wind speed such that the user may account for the wind speed and direction in aiming along a path. In some embodiments, a single characteristic vector for crosswind velocity and direction, or a holdover value, or a disturbed reticule may be provided to the user.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement using the exemplary techniques described herein, and that embodiments are not limited to being implemented in any specific number, division, or type of functional facilities. In some implementations, all functionalities may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

Further, some techniques described above comprise acts of storing information (e.g., data and/or instructions) in certain ways for use by these techniques. In some implementations of these techniques—such as implementations where the techniques are implemented as computer-executable instructions—the information may be encoded on a computer-readable storage media. Where specific structures are described herein as advantageous formats in which to store this information, these structures may be used to impart a physical organization of the information when encoded on the storage medium. These advantageous structures may then provide functionality to the storage medium by affecting operations of one or more processors interacting with the information; for example, by increasing the efficiency of computer operations performed by the processor(s).

In some, but not all, implementations in which the techniques may be embodied as computer-executable instructions, these instructions may be executed on one or more suitable computing device(s) operating in any suitable computer system, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing device (co-located or geographically distributed) dedicated to executing the techniques described herein, one or more Field-Programmable Gate Arrays (FPGAs) for carrying out the techniques described herein, or any other suitable system.

FIG. 6 illustrates one example of an implementation of a computing device in the form of computing device 600 that may be used in a system implementing techniques described herein, in accordance with some embodiments. It should be appreciated that FIG. 6 is intended neither to be a description of necessary components for a computing device to operate as a projectile trajectory facility, in accordance with the techniques described herein, nor a comprehensive depiction.

Computing device 600 may include at least one processor 602, at least one network adapter 604, and at least one non-volatile computer-readable storage media 606. Computing device 600 may be, for example, a desktop or laptop personal computer, a personal digital assistant, a smart mobile phone, ballistic calculation equipment, or any other suitable computing device. Network adapter 604 may be any suitable hardware and/or software to enable the computing device 600 to communicate through wired and/or wireless connections with any other suitable computing device over any suitable computing network and using any suitable networking protocol, as described herein. The computing network may include switches, routers, gateways, access points, and/or other networking equipment as well as any suitable wired and/or wireless communication medium or media for exchanging data between two or more computers, including the Internet. Non-volatile computer readable storage media 606 may be adapted to store data to be processed and/or instructions to be executed by processor 602. Processor 602 enables processing of data and execution of instructions. The data instructions may be stored on the computer-readable storage media 606. The processor 602 may control writing data to and reading data from the non-volatile computer-readable storage media 606 and memory 610 in any suitable manner, as the aspects of the disclosure provided herein are not limited in this respect.

The data and instructions stored on computer-readable storage media 606 may include computer-executable instructions implementing techniques which operate according to the techniques described herein. In the example of FIG. 6, non-volatile computer-readable storage media 606 stores computer-executable instructions implementing various facilities and storing various information, as described above. Non-volatile computer-readable storage media 606 may store a projectile trajectory facility, in accordance with some embodiments described herein.

While not illustrated in FIG. 6, a computing device may additionally have one or more components and peripherals, including input and output devices. These devices can be used, among other things to present a user interface. Examples of output devices that can be used to provide a user interface include printers or display screens for visual presentation of output and speakers or other sound generating devices for audible presentation of output. Example of input devices that can be used for a user interface include keyboards, and pointing devices, such as mice, touch pads, and digitizing tablets. As another example, a computing device may receive input information through speech recognition or in other audible format.

Techniques operating according to the principles described herein may be implemented in any suitable manner. The processing and decision blocks of the flowcharts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the spirit and scope of the principles described herein. Accordingly, the foregoing description and drawings are by way of example only.

What is claimed is:

1. A method for determining an estimated trajectory for a projectile, the method comprising:
detecting, using a neuromorphic camera, event data indicative of a change of optical flux;
determining, based at least in part on the event data, at least one optical shift indicative of a wind speed profile and/or a turbulence profile; and
determining, based at least in part on the at least one optical shift, the estimated trajectory for the projectile.

2. The method of claim 1, wherein determining the estimated trajectory for the projectile further comprises:
determining, based at least in part on the at least one optical shift, a wind speed and a wind direction; and
determining, based at least in part on the wind speed and the wind direction, the estimated trajectory for the projectile.

3. The method of claim 1, wherein the event data is first event data detected at a first focal plane and determining the estimated trajectory further comprises detecting second event data at a second focal plane.

4. The method of claim 1, wherein determining the estimated trajectory for the projectile comprises using an artificial intelligence technique to determine the estimated trajectory for the projectile based at least in part on the at least one optical shift.

5. The method of claim 1, wherein determining the at least one optical shift comprises:
identifying a contrast region in a field of view of the neuromorphic camera; and
determining, based at least in part on event data from the contrast region, the at least one optical shift indicative of the wind profile and/or the turbulence profile along a path toward at least one object in the field of view of the neuromorphic camera.

6. The method of claim 5, wherein an edge detection algorithm is used to identify the contrast region.

7. The method of claim 5, wherein identifying the contrast region comprises a user selecting the contrast region.

8. The method of claim 5, wherein identifying the contrast region comprises using an artificial intelligence technique to identify the contrast region.

9. A system for determining a wind profile and/or an atmospheric turbulence profile associated with an estimated trajectory for a projectile, the system comprising:
a neuromorphic camera; and
at least one non-transitory computer-readable storage medium storing processor-executable instructions that, when executed by at least one computer hardware processor, cause the at least one computer hardware processor to perform a method for determining the estimated trajectory for the projectile, the method comprising:
detecting, using the neuromorphic camera, event data indicative of a change of optical flux;
determining, based at least in part on the event data, at least one optical shift; and
determining, based at least in part on the at least one optical shift, the wind profile and/or the atmospheric turbulence profile.

10. The system of claim 9, further comprising a lens configured to direct light onto a detector of the neuromorphic camera.

11. The system of claim 10, wherein the lens is included in an optical scope.

12. The system of claim 9, further comprises:
determining, based at least in part on the at least one optical shift, a wind speed, and a wind direction; and
determining, based at least in part on the wind speed and the wind direction, the estimated trajectory for the projectile.

13. The system of claim 9, wherein determining the estimated trajectory for the projectile comprises using an artificial intelligence technique to determine the estimated trajectory for the projectile based at least in part on the at least one optical shift.

14. The system of claim 9, wherein determining the at least one optical shift comprises:
identifying a contrast region in a field of view of the neuromorphic camera; and
determining, based at least in part on event data from the contrast region, the at least one optical shift.

15. The system of claim 9, wherein the event data is first event data detected at a first focal plane and determining the wind profile and/or the atmospheric turbulence profile further comprises detecting second event data at a second focal plane.

16. A system for determining a wind profile and/or an atmospheric turbulence profile associated with an estimated trajectory for a projectile, the system comprising:
a neuromorphic camera; and
at least one non-transitory computer-readable storage medium storing processor-executable instructions that, when executed by at least one computer hardware processor, cause the at least one computer hardware processor to perform a method for determining the estimated trajectory for the projectile, the method comprising:
detecting, using the neuromorphic camera, first event data at a first focal plane, the first event data being indicative of a first change of optical flux;
detecting, using the neuromorphic camera, second event data at a second focal plane, the second event data being indicative of a second change of optical flux; and
determining at least one optical shift indicative of the wind profile and/or the atmospheric turbulence profile using at least the first and second event data; and
determining, based at least in part on the at least one optical shift, the wind profile and/or the atmospheric turbulence profile.

17. The system of claim 16, wherein the method for determining the wind profile and/or the atmospheric turbulence profile associated with the estimated trajectory for the projectile, further comprises detecting a third event data at a third focal plane, the third event data being indicative of a third change of optical flux.

18. The system of claim 16, wherein the first event data is detected from a first region of interest of the first focal plane and the second event data is detected from a second region of interest of the second focal plane.

19. The system of claim 18, wherein the first region of interest corresponds to a first set of pixels of the neuromorphic camera and the second region of interest corresponds to a second set of pixels of the neuromorphic camera, wherein the first set of pixels and the second set of pixels are the same sets of pixels, different sets of pixels, or partially the same sets of pixels.

20. The system of claim 16, wherein determining the wind profile and/or the atmospheric turbulence profile associated with the estimated trajectory for the projectile further comprises:
determining a first optical shift using the first event data;
determining a second optical shift using the second event data;
determining, based at least in part on the first optical shift and the second optical shift, a wind speed, and a wind direction; and
determining, based at least in part on the wind speed and the wind direction, the estimated trajectory for the projectile.
